(19) United States
(12) Patent Application Publication
(10) Pub. No.: US 2016/0036902 A1
(43) Pub. Date: Feb. 4, 2016

(54) METHOD AND APPARATUS FOR SHARING CONTENT BETWEEN DEVICES IN PEER-TO-PEER NETWORKS

(71) Applicant: Google Technology Holdings LLC, Mountain View, CA (US)

(72) Inventors: Akila Varadarajan, Libertyville, IL (US); Jagadish Kumar Agrawal, Santa Clara, CA (US); Sujoy Das, Grayslake, IL (US)

(21) Appl. No.: 14/447,818

(22) Filed: Jul. 31, 2014

(51) Int. Cl. H04L 29/08

(52) U.S. Cl. CPC H04L 67/104; H04L 67/1095

(57) ABSTRACT

A method and apparatus share content between devices in peer-to-peer networks. A first connection between a first peer device and a second peer device can be established in a first peer-to-peer network. A second connection between the second peer device and a third peer device can be established in a second peer-to-peer network. A content request can be received at the second peer device from the first peer device, where the content request is a request for requested content. The second peer device can determine that it does not have the requested content. The second peer device can store the content request when it does not have the requested content. The second peer device can forward the content request to the third peer device if the second peer device does not have the requested content.

### BACKGROUND

1. Field

The present disclosure is directed to a method and apparatus for sharing content between devices in peer-to-peer networks.

2. Introduction

Presently, devices form peer-to-peer networks where each device can be a peer device that acts as a server for other peer devices. This allows shared access to files and peripherals without the need for a central server. When a first peer device desires a specific file with specific content, a second peer device provides the content to the first device. Unfortunately, the devices on the first peer device's peer-to-peer network may not have the content. Therefore, the first peer device will not receive the content, even if it is present on other peer-to-peer networks. For example, the first peer device may desire a picture of an apple. However, if none of the devices on the first peer device's network have the desired apple picture, the first peer device cannot obtain it from its peer-to-peer network. Even if the apple picture exists elsewhere, the first peer device will not obtain it from its own peer-to-peer network.

Thus, there is a need for a method and apparatus for sharing content between devices in peer-to-peer networks.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope.

FIG. 1 is an example block diagram of a system according to a possible embodiment;

FIG. 2 is an example block diagram of a system according to a possible embodiment;

FIG. 3 is an example flowchart illustrating the operation of a peer device according to a possible embodiment;

FIG. 4 is an example flowchart illustrating the operation of a peer device according to a possible embodiment;

FIG. 5 is an example flowchart illustrating the operation of a peer device according to a possible embodiment; and

FIG. 6 is an example block diagram of an apparatus, such as a peer device, according to a possible embodiment.

### DETAILED DESCRIPTION

Embodiments provide a method and apparatus that share content between devices in peer-to-peer networks. A first connection between a first peer device and a second peer device can be established in a first peer-to-peer network. A second connection between the second peer device and a third peer device can be established in a second peer-to-peer network. A content request can be received at the second peer device from the first peer device, where the content request is a request for requested content. The second peer device can determine that it does not have the requested content. The second peer device can store the content request when it does not have the requested content. The second peer device can forward the content request to the third peer device if the second peer device does not have the requested content.

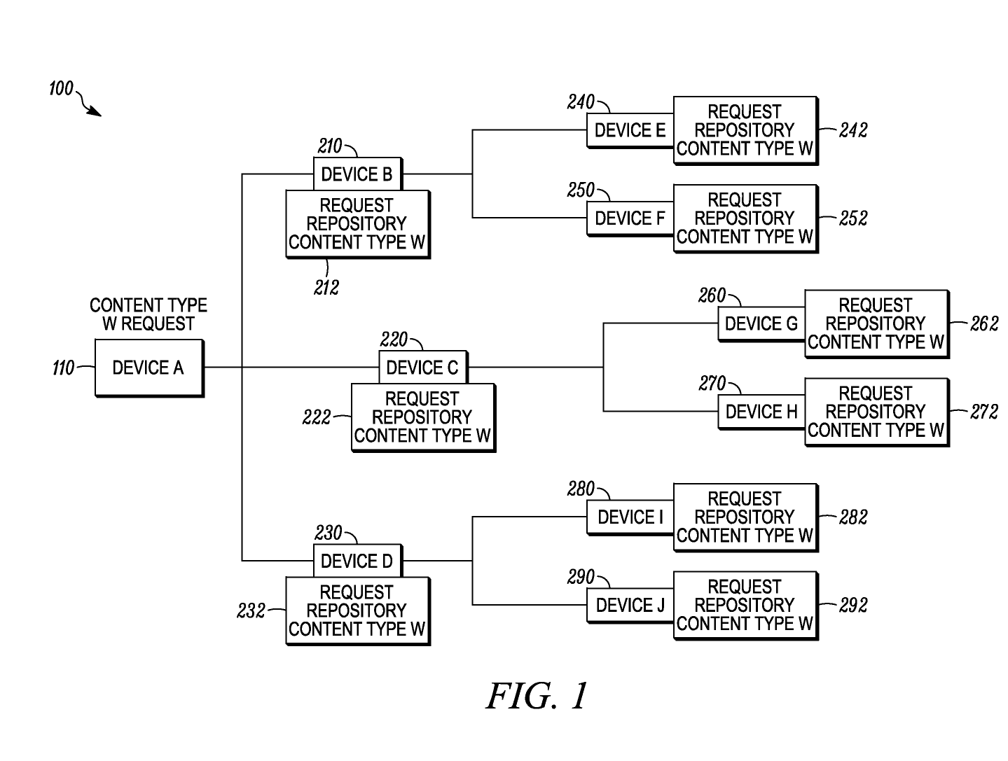

FIG. 1 is an example block diagram of a system 100 according to a possible embodiment. The system 100 can include peer devices 110, 210, 220, 230, 240, 250, 260, 270, 280, and 290. The peer devices 110, 210, 220, 230, 240, 250, 260, 270, 280, and 290 can be portable wireless communication devices, selective call receivers, smartphones, smart glasses, smart watches, cellular telephones, personal digital assistants, personal computers, laptop computers, tablet computers, or any other devices that are capable of sending and receiving communication signals on a network. The peer devices 110, 210, 220, 230, 240, 250, 260, 270, 280, and 290 can be peer devices in various peer-to-peer networks. Peer-to-peer networks can be short range wireless communication peer-to-peer networks, Wireless Local Area Network (WLAN)-based peer-to-peer networks, Wi-Fi-based peer-to-peer networks, such as Wi-Fi direct networks, Bluetooth peer-to-peer networks, wired peer-to-peer networks, torrent peer-to-peer networks, and other peer-to-peer networks. The peer-to-peer networks can also be private protected peer to peer networks that require authentication for devices to connect to the network. The peer devices 210, 220, 230, 240, 250, 260, 270, 280, and 290 can have request repositories 212, 222, 232, 242, 252, 262, 272, 282, and 292, respectively. The request repositories 212, 222, 232, 242, 252, 262, 272, 282, and 292 can be memories, flash memories, hard drives, optical drives, thumb drives, cache memories, sections of memories, tables in memories, or any other means of storing data, such as a content request.

In operation, a first peer device 110 can send a content request that requests whether certain content W of a certain content type is available from its peers, such as peer devices 210, 220, and 230 in a first peer-to-peer network with peer device 110. The content W can be an image, an audio file, a document, or any other content that can be shared between devices. If the peer devices 210, 220, and 230 do not have the content W, they can place the content W request in their request repositories 212, 222, and 232, respectively. The content request can be propagated to peer devices 240, 250, 260, 270, 280, and 290 in each of the peer device's 210, 220, and 230 own peer networks and all of the peer devices 240, 250, 260, 270, 280, and 290 can place the content request in their own respective repositories 242, 252, 262, 272, 353, and 292. For example, peer device 210 can be a second peer device in a second peer-to-peer network including peer devices 240 and 250, where peer device 240 can be a third peer device. The terms “first,” “second,” and “third” are only used to differentiate different peer devices and do not necessarily imply an order or sequence of peer devices. Furthermore, any of the peer devices 110, 210, 220, 230, 240, 250, 260, 270, 280, and 290 can be first, second, or third peer devices.

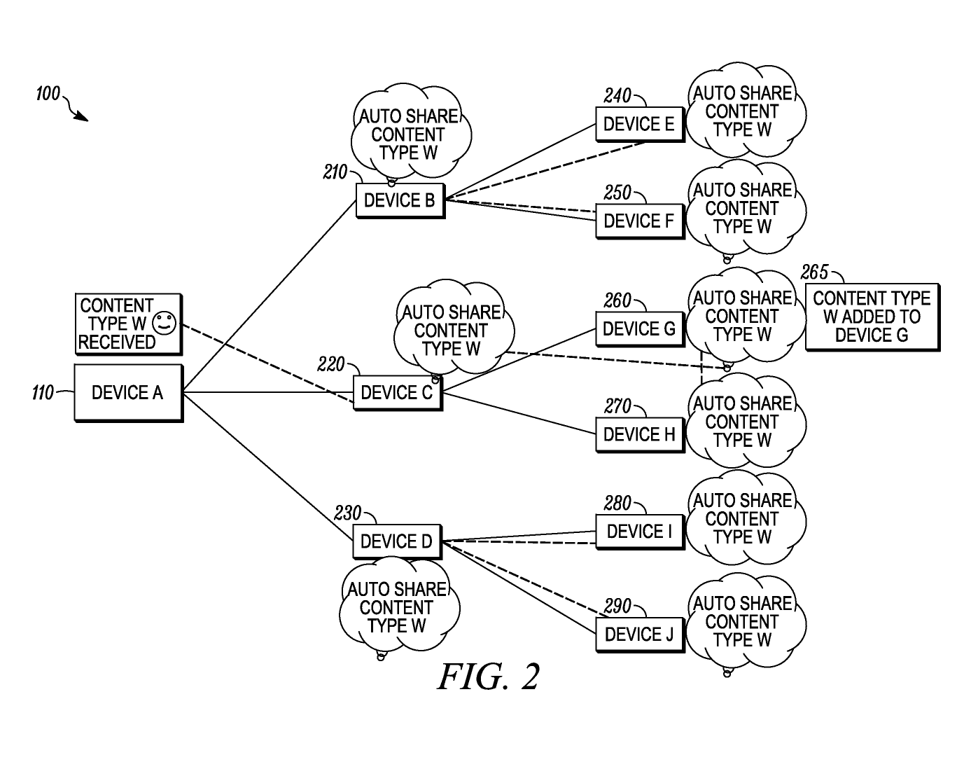

FIG. 2 is an example block diagram of the system 100 according to a possible embodiment. In operation, when the requested content W 265 becomes available at one peer device 260, the peer device 260 can automatically share the content W 265 in the sharable space in the peer-to-peer networks between the peer devices 110, 210, 220, 230, 240, 250, 260, 270, 280, and 290. For example, when each peer device receives the content W 265, they can automatically share the content W 265 in their own peer-to-peer network space and the content W 265 can again get propagated to each of the peer device's peers until it the requesting peer device 110 receives the content W 265.

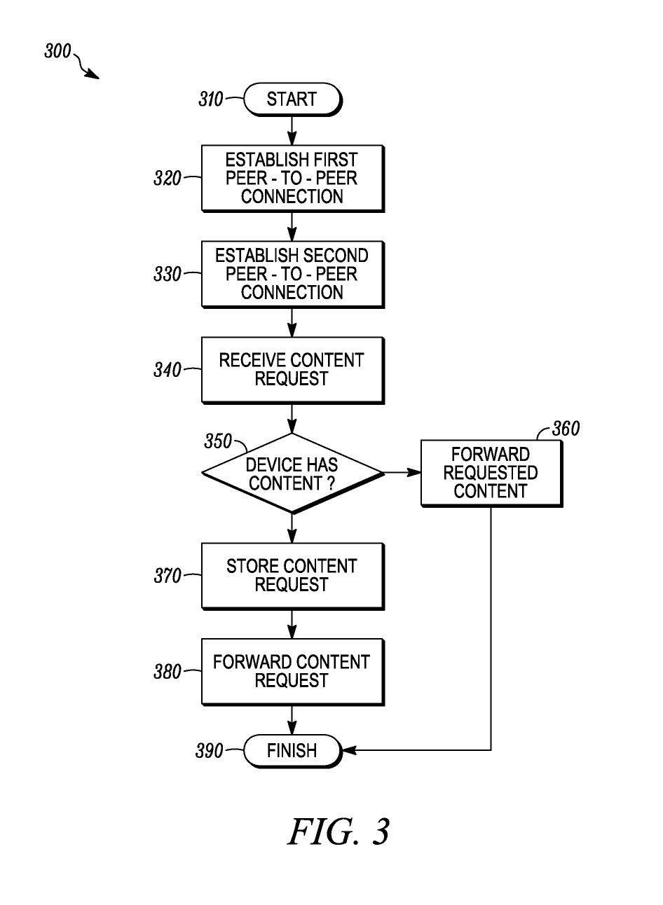

FIG. 3 is an example flowchart 300 illustrating the operation of the peer device 210 or any other peer device according to a possible embodiment. At 310, the flowchart 300 can begin. At 320, a first connection can be established between a first peer device and a second peer device in a first peer-to-peer network, where the second peer device can be the peer device 210. At 330, a second connection can be established between the second peer device and a third peer device in a second peer-to-peer network. The second peer-to-peer network can have at least one level of peers and the second peer device and the third peer device can be siblings in the same level of the at least one level of peers in the second peer-to-peer network. For example, the second peer-to-peer network can have parent and child devices on different levels and the second peer device and the third peer device can be siblings in the second peer-to-peer network. Alternately, the peer devices can be at separate levels in one or more peer-to-peer networks. The first peer-to-peer network can also have at least one level of peers and the first peer device and the second peer device can be siblings in the same level of the at least one level of peers in the first peer-to-peer network. Furthermore, the first peer-to-peer network can be the same peer-to-peer network as the second peer-to-peer network or they can be different peer-to-peer networks.

At 340, a content request can be received at the second peer device from the first peer device, where the content request is a request for requested content. The first peer device can be the originator of the content request or can be a peer device that receives and forwards the content request to the second peer device, which then forwards the content request to the third peer device. The content request can include keywords identifying the requested content and includes a device identifier that identifies the first peer device. For example, the content request can include an actual search keyword, other keywords, search terms, pictures, audio, media types, file types, and/or other useful information for identifying the subject of a content request. The content request can also include an identifier of the requesting device, identifiers of intermediary peer devices that forwarded the content request, physical addresses of the requesting device and intermediary devices, a date of the request, a request expiration identifier, and/or other useful information. The request expiration identifier can include an original request date, a request time period, a request expiration date, or any other information that can indicate when the content request might expire, such as after a predetermined time period.

At 350, the second peer device can determine whether it has the requested content. If the second peer device has the requested content, at 360, the second peer device can forward the content to the first peer device. If the second peer device does not have the requested content, at 370 the second peer device can store the content request. The content request can be stored in a content request repository, such as in a memory, at the second peer device. At 380, the second peer device can forward the content request to the third peer device. Before forwarding the content request, the second peer device can add a device identifier of the second peer device to the content request. Thus, the content request can include an identifier of the requesting device as well as device identifiers of some or all of the intermediary requesting devices. The content request may or may not include this history of the intermediary requesting devices. At 390, the flowchart 300 can end.

For example, devices can keep propagating the content request to their peers that store and forward the content request to their own peers. When one of the peers identifies that it has content that matches the content request, it can automatically share the content with its peers that stored the content request, and the peers can back propagate the content to the original requesting device as well as other peer devices that desire the content.

The first peer-to-peer network including the first peer device and the second peer device can be a different peer-to-peer network from the second peer-to-peer network including the second peer device and the third peer device. The first peer device, the second peer device, and the third peer device can also be in the same peer-to-peer network, can connect to the same peer-to-peer network at different times, and can otherwise connect to related and unrelated networks. For example, the third peer device can connect to another network where it receives the requested content. The third peer device can then connect to the second peer-to-peer network and provide the requested content to the second peer device, which then can provide the requested content to the first peer device. The third peer device can also receive the requested content via e-mail, retrieve the requested content from the Internet, or otherwise obtain the requested content. The third peer device can also generate the requested content, such as by taking a picture or making a recording, creating a document, or by otherwise generating the requested content, and can then provide the requested content to the second peer device. The second peer device can similarly retrieve or generate the requested content to directly provide it to the first peer device.

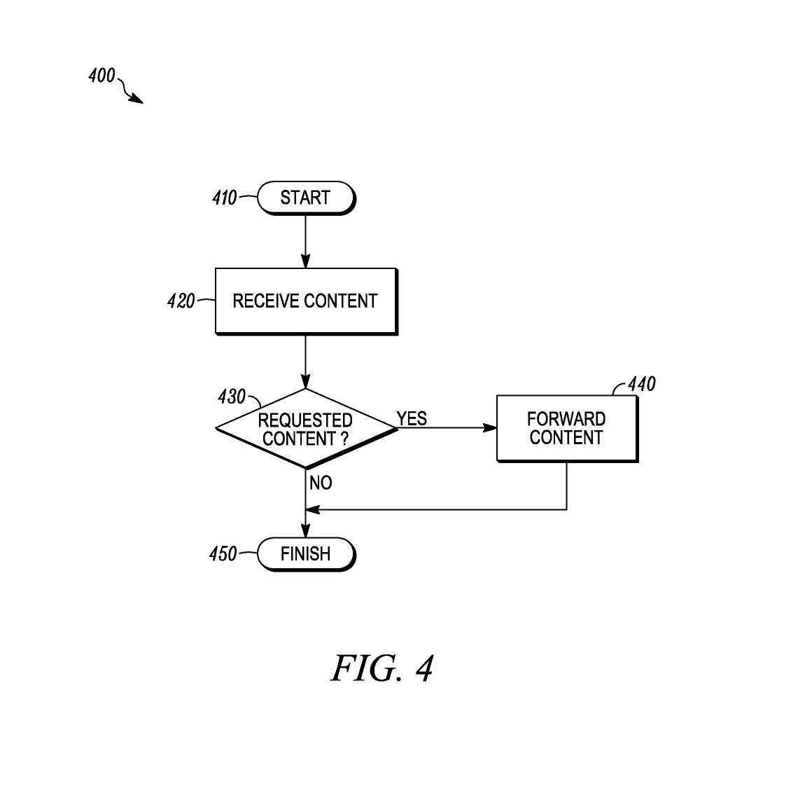

FIG. 4 is an example flowchart 400 illustrating the operation of the peer device 210, or any other peer device, according to a possible embodiment. The peer device 210 can be a second peer device that received a content request from a first peer device and forwarded the content request to a third peer device. At 410, the flowchart 400 can begin. At 420, the second peer device can receive the requested content from the third peer device after forwarding the content request to the third peer device. At 430, the second peer device can ascertain whether the received content is the content requested in the stored content request. For example, a peer device can ascertain whether the received content is the requested content based on filename matching, based on metadata matching, based on keyword matching, based on image matching, based on audio matching, or based on any other method of determining whether content corresponds to a content request. At 440, if the received content is the content requested in the stored content request, the second peer device can forward the received content to the first peer device. At 450, the flowchart 400 can end.

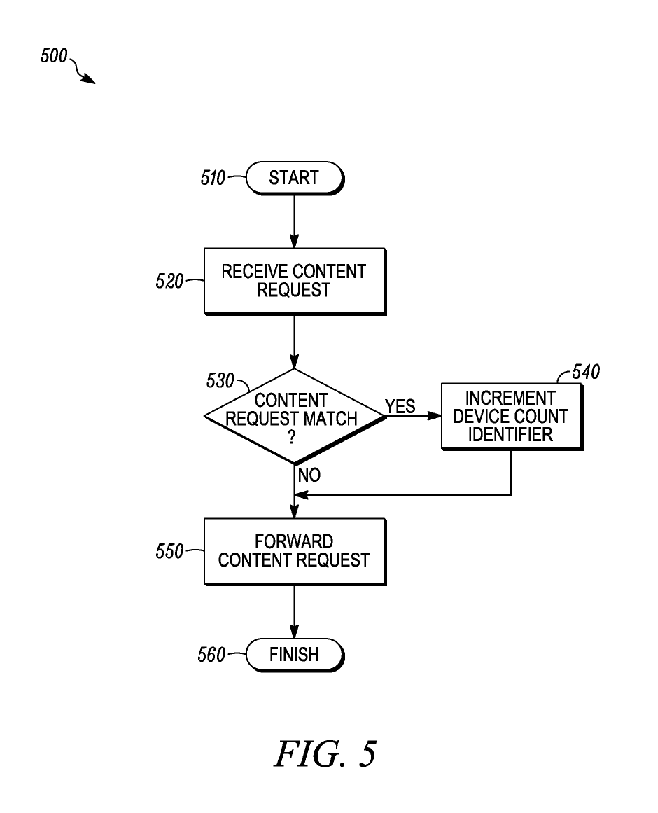

FIG. 5 is an example flowchart 500 illustrating the operation of the peer device 210, such as a second peer device, or any other peer device according to a possible embodiment. At 510, the flowchart 500 can begin. At 520, the second peer device can receive a first content request from a first peer device. The first content request can include a device count identifier that identifies a number of devices requesting the requested content. Before receiving the first content request, the second peer device may have already stored another content request, such as a second content request. At 530, the second peer device can determine whether the received first content request matches the stored second content request. If the first content request matches the stored second content request, at 540, the second peer device can increment the device count identifier. At 550, the second peer device can forward the content request with the incremented device count identifier. At 560, the flowchart 500 can end.

For example, once the content request initiating peer device receives content, the request may be deleted from the other peer device content request repositories. If the content request is of high value or importance to other peer devices, the request can be maintained in the content request repositories based on a number of devices identified by the device count identifier. Thus the content request can be kept it if other peer devices are requesting it, but have not yet received it. As a further example, if a certain number of peer devices are requesting the same content, the content request can be maintained it in the device repositories for a certain time period. Information regarding the number of devices requesting the content can be propagated with the content request. For example, a peer device can determine request exists, can increment a request count field, such as the device count identifier, and can forward the updated content request. This can also help determine which content is of high value. The content request can also have a content request identifier and the second peer device can determine if the content request has already been received based on the content request identifier and then may or may not increment the device count identifier if the particular content request has already been received. The second peer device can also determine if the content request has already been received based on the device identifier in the content request. Thus, if the device identifier in a received content request identifies the same requesting device as the stored content request device identifier, the second peer device may not increment the device count identifier. However, if the device identifier identifies the received content request as being from a different peer device than that of the stored content request, the second peer device can increment the device count identifier and forward the content request.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed and different steps can be interchanged in between different flowcharts. Furthermore, different steps can be performed by different elements or in a single element of the disclosed embodiments.

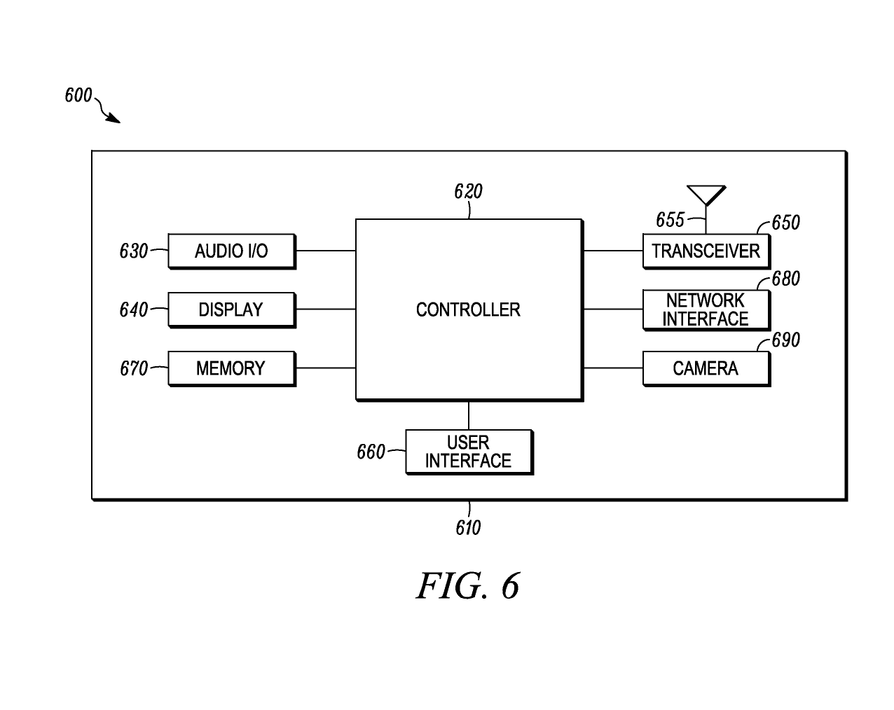

FIG. 6 is an example block diagram of an apparatus 600, such as the peer device 210 or any other peer device, according to a possible embodiment. The apparatus 600 can include a housing 610, a controller 620 within the housing 610, audio input and output circuitry 630 coupled to the controller 620, a display 640 coupled to the controller 620, a transceiver 650 coupled to the controller 620, an antenna 655 coupled to the transceiver 650, a user interface 660 coupled to the controller 620, a memory 670 coupled to the controller 620, a network interface 680 coupled to the controller 620, and an image capture device 690 coupled to the controller 620. The apparatus 600 can perform the methods described in all the embodiments.

The display 640 can be a viewfinder, such as a liquid crystal display (LCD), a light emitting diode (LED) display, a plasma display, a projection display, a touch screen, or any other device that displays information. The transceiver 650 may include a transmitter and/or a receiver. The transceiver can also be a wired or wireless transceiver. The audio input and output circuitry 630 can include a microphone, a speaker, a transducer, or any other audio input and output circuitry. The user interface 660 can include a keypad, a keyboard, buttons, a touch pad, a joystick, a touch screen display, another additional display, or any other device useful for providing an interface between a user and an electronic device. The image capture device 690 can be a camera, a video camera, a webcam, an electronic image sensor, or any other image capture device. The network interface 680 can be a universal serial bus port, an Ethernet port, an infrared transmitter/receiver, an IEEE 1394 port, or any other interface that can connect an apparatus to a network or computer and that can transmit and receive data communication signals. According to some embodiments, the network interface 680 can also be considered a transceiver. The memory 670 can include a random access memory, a read only memory, an optical memory, a subscriber identity module memory, a flash memory, a removable memory, a hard drive, a cache, or any other memory that can be coupled to a peer device.

The apparatus 600 or the controller 620 may implement any operating system, such as Microsoft Windows®, UNIX, or LINUX, Android, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 670 or elsewhere on the apparatus 600. The apparatus 600 or the controller 620 may also use hardware to implement operations. For example, the controller 620 may be any programmable processor. Disclosed embodiments may also be implemented on a general-purpose or a special purpose computer, a programmed microprocessor or microprocessor, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 620 may be any controller or processor device or devices capable of operating an electronic device and implementing the disclosed embodiments. As a further example, embodiments can be implemented using computer-executable instructions, such as program modules, being executed by an electronic device, such as a general purpose computer. Generally, program modules can include routine programs, objects, components, data structures, and other program modules that perform particular tasks or implement particular abstract data types. The program modules may be software-based and/or may be hardware-based. For example, the program modules may be stored on computer readable storage media, such as the memory 670, such as hardware discs, flash drives, optical drives, solid state drives, CD-ROM media, thumb drives, and other computer readable storage media that provide non-transitory storage aside from a transitory propagating signal. Moreover, embodiments may be practiced in network computing environments with many types of computer system configurations, including personal computers, hand-held devices, multi-processor systems, microprocessor-based or programmable consumer electronics, network personal computers, minicomputers, mainframe computers, and other computing environments.

In operation, the transceiver 650 can establish a first connection between a first peer device and the apparatus 600 in a first peer-to-peer network. The transceiver 650 can also establish a second connection between the apparatus 600 and a second peer device in a second peer-to-peer network. The first connection and the second connection can be concurrent connections or can be made at different times. The transceiver 650 can receive a content request from the first peer device, where the content request can be a request for requested content. The controller 620 can determine that the apparatus does not have the requested content. The controller 620 can store the content request in the memory 670 if the apparatus 600 does not have the requested content. The controller 620 can forward the content request to the second peer device via the transceiver 650 if the apparatus 600 does not have the requested content. The controller 620 can add a device identifier of the apparatus 600 to the content request before forwarding the content request from the apparatus 600 to the second peer device.

The content request can be a first content request and the memory 670 can store a previously received second content request. The controller 620 can determine the first content request matches the stored second content request, can increment a device count identifier in the content request if the first content request matches the stored second content request, and can forward the content request with the incremented device count identifier via the transceiver 650.

The transceiver 650 can receive content at the apparatus 600 from the second peer device after the controller 620 has stored the content request in the memory 670. The controller 620 can ascertain the received content is the content requested in the stored content request and can forward the received content to the first peer device via the transceiver 650 if the received content is the content requested in the stored content request.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of” followed by a list is defined to mean one, some, or all, but not necessarily all of, the elements in the list. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

We claim:

1. A method comprising:
establishing a first connection between a first peer device and a second peer device in a first peer-to-peer network;
establishing a second connection between the second peer device and a third peer device in a second peer-to-peer network;
receiving a content request at the second peer device from the first peer device, where the content request is a request for requested content;
determining that the second peer device does not have the requested content;
storing the content request at the second peer device when the second peer device does not have the requested content; and
forwarding the content request from the second peer device to the third peer device if the second peer device does not have the requested content.

2. The method according to claim 1, further comprising:
receiving content at the second peer device from the third peer device after forwarding the content request to the third peer device;
ascertaining the received content is the content requested in the stored content request; and
forwarding the received content from the second peer device to the first peer device if the received content is the content requested in the stored content request.

3. The method according to claim 1,
wherein the second peer-to-peer network comprises at least one level of peers, and p1 wherein the second peer device and the third peer device are siblings in the same level of the at least one level of peers in the second peer-to-peer network.

4. The method according to claim 1, wherein the first peer-to-peer network including the first peer device and the second peer device is a different peer-to-peer network from the second peer-to-peer network including the second peer device and the third peer device.

5. The method according to claim 1,
wherein the first connection is established by the second peer device, and
wherein the second connection is established by the second peer device.

6. The method according to claim 1, wherein the content request includes keywords identifying the requested content and includes a device identifier that identifies the first peer device.

7. The method according to claim 6, further comprising adding a device identifier of the second peer device to the content request before forwarding the content request from the second peer device to the third peer device.

8. The method according to claim 1, wherein the content request includes expiration information identifying when the content request expires.

9. The method according to claim 1, wherein the content request includes a device count identifier that identifies a number of devices requesting the requested content.

10. The method according to claim 9,
wherein the content request comprises a first content request,
wherein the method further comprises:
determining the first content request matches a stored second content request; and
incrementing the device count identifier if the first content request matches the stored second content request, and p1 wherein forwarding the content request comprises forwarding the content request with the incremented device count identifier.

11. An apparatus comprising:
a controller;
a transceiver coupled to the controller, the transceiver configured to establish a first connection between a first peer device and the apparatus in a first peer-to-peer network, configured to establish a second connection between the apparatus and a second peer device in a second peer-to-peer network, configured to receive a content request from the first peer device, where the content request is a request for requested content; and
a memory coupled to the controller,
wherein the controller is configured to determine that the apparatus does not have the requested content, configured to store the content request in the memory if the apparatus does not have the requested content and configured to forward the content request to the second peer device via the transceiver if the apparatus does not have the requested content.

12. The apparatus according to claim 11,
wherein the transceiver is configured to receive content at the apparatus from the second peer device after the controller has stored the content request in the memory, and
wherein the controller is configured to ascertain the received content is the content requested in the stored content request and configured to forward the received content to the first peer device via the transceiver if the received content is the content requested in the stored content request.

13. The apparatus according to claim 11,
wherein the second peer-to-peer network comprises at least one level of peers, and
wherein the apparatus and the second peer device are in the same level of the at least one level of peers in the second peer-to-peer network.

14. The apparatus according to claim 11, wherein the first peer-to-peer network including the first peer device and the apparatus is a different peer-to-peer network from the second peer-to-peer network including the apparatus and the second peer device.

15. The apparatus according to claim 11, wherein the content request includes keywords identifying the requested content and includes a device identifier that identifies the first peer device.

16. The apparatus according to claim 15, wherein the controller is configured to add a device identifier of the apparatus to the content request before forwarding the content request from the apparatus to the second peer device.

17. The apparatus according to claim 11, wherein the content request includes expiration information identifying when the content request expires.

18. The apparatus according to claim 11, wherein the content request includes a device count identifier that identifies a number of devices requesting the requested content.

19. The apparatus according to claim 18,
wherein the content request comprises a first content request,
wherein the memory stores a second content request,
wherein the controller is configured to determine the first content request matches the stored second content request, is configured to increment the device count identifier if the first content request matches the stored second content request, and is configured to forward the content request with the incremented device count identifier via the transceiver.

20. A method comprising:
establishing a first connection between a first peer device and a second peer device at the second peer device in a first peer-to-peer network;
establishing, at the second peer device, a second connection between the second peer device and a third peer device in a second peer-to-peer network;
receiving a content request at the second peer device from the first peer device, where the content request is a request for requested content, and where the content request includes information identifying the requested content and includes a device identifier that identifies the first peer device;
determining by the second peer device that the second peer device does not have the requested content;
storing the content request at the second peer device when the second peer device does not have the requested content;
forwarding the content request from the second peer device to the third peer device if the second peer device does not have the requested content;
receiving content at the second peer device from the third peer device after forwarding the content request;
ascertaining at the second peer device that the received content is the content requested in the stored content request; and
forwarding the received content from the second peer device to the first peer device if the received content is the content requested in the stored content request.
